(19) United States
(12) Patent Application Publication
(10) Pub. No.: US 2006/0027059 A1
(43) Pub. Date: Feb. 9, 2006

(54) Extendable handle device

(76) Inventor: Chih-Ching Hsien, Taichung Hsien (TW)

Correspondence Address: Chih-Ching Hsien, 235 Chung-Ho, Box 8-24, Taipei, TW

(21) Appl. No.: 10/913,577

(22) Filed: Aug. 9, 2004

(51) Int. Cl. B25G 1/01

(52) U.S. Cl. 81/489

(57) ABSTRACT

An extendable handle device comprises a handle; an upper opening end of the handle having an inner thread; a handle rod having at least one outer thread at an outer wall thereof and a resisting device. When the handle is engaged to the handle rod, the inner thread is used to engage one of the at least one outer thread so as to increase the stability of the engagement; an inner wall of the handle is formed with at least one annular trench; the resisting device can resist against one of the at least one annular trench. The resisting device includes a steel ball and a spring. The outer wall of the handle rod has an upper outer thread and a lower outer thread. The extendable handle device is a spanner with only one handle rod, or the extendable handle device is a damper with two handle rods.

### FIELD OF THE INVENTION

The present invention relates to handle devices, and particularly to an extendable handle device, wherein the formations of outer threads of the handle rod and the inner thread of the handle are helpful to the stability of the engagement of the handle rod to the handle.

### BACKGROUND OF THE INVENTION

In the prior art, the length of the handle of a handle tool is fixed so that it cannot be used in various conditions. As a result, the user must prepare various tools with different lengths to match the requirement of the workspace. However this is inconvenient because the user must carry a larger amount of tools which are heavy. Furthermore, a larger space is necessary to store these tools and the cost for working is increased. Furthermore, if the handle tool is too long, it is very possible that the long tool is inconvenient to be placed in a handle box, even it cannot be placed in the box.

Thereby there is an eager demand for a novel extendable handle device which can improve the defects in the prior art.

### SUMMARY OF THE INVENTION

Accordingly, the primary object of the present invention is to provide an extendable handle device, wherein the formations of the upper outer thread, the outer threads of the handle rod and the inner thread of the handle are helpful to the stability of the engagement of the handle rod and the handle.

Another object of the present invention is to provide an extendable handle device, wherein a maximum extension length is achieved by engaging the lower outer thread of the handle rod to the lower outer thread of the handle.

A further object of the present invention is to provide an extendable handle device, wherein the handle has a larger lower end and a smaller upper end so that the handle rod is easily slidable within the handle.

Furthermore, in the present invention, an outer surface of the handle can be enclosed with a layer of plastic material so as to provide a preferred holding feeling and outlook to users.

To achieve above objects, the present invention provides An extendable handle device comprises a handle; an upper opening end of the handle having an inner thread; a handle rod having at least one outer thread at an outer wall thereof and a resisting device. When the handle is engaged to the handle rod, the inner thread is used to engage one of the at least one outer thread so as to increase the stability of the engagement; an inner wall of the handle is formed with at least one annular trench; the resisting device can resist against one of the at least one annular trench. The resisting device includes a steel ball and a spring. The outer wall of the handle rod has an upper outer thread and a lower outer thread. The extendable handle device is a spanner with only one handle rod, or the extendable handle device is a damper with two handle rods.

The various objects and advantages of the present invention will be more readily understood from the following detailed description when read in conjunction with the appended drawing.

### BRIEF DESCRIPTION OF THE DRAWINGS

FIG. 1 is an exploded perspective view of extendable handle device of the present invention.

FIG. 2 is a partial perspective view of the extendable handle device of the present invention.

FIG. 3 is a partial cross sectional view of the extendable handle device of the present invention.

FIG. 4 is a schematic cross view of the extendable handle device of the present invention.

FIG. 5 is a schematic view of the extendable handle device of the present invention, wherein the handle rod is extended.

FIGS. 6 and 7 are schematic views of the second embodiment of the extendable handle device of the present invention.

FIGS. 8 and 9 are schematic views about the third embodiment of the extendable handle device of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

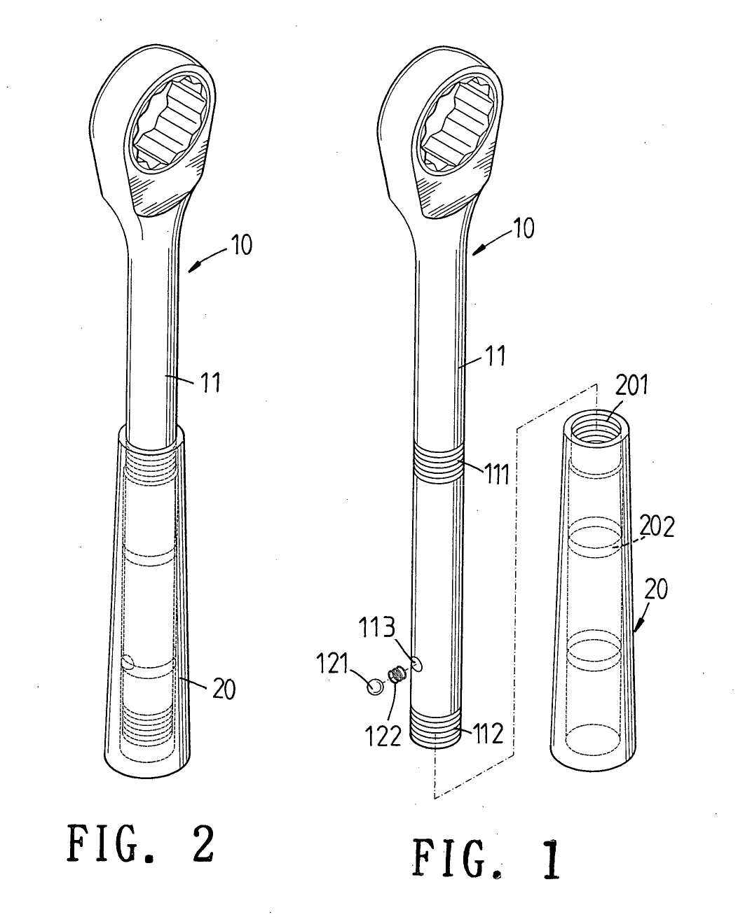

Referring to FIG. 1 and 2, the extendable handle device of the present invention is illustrated. The extendable handle device has a tool body 10, in the following a spanner is used as an example. However the present invention can be used to various structures, which is not confined to the spanner.

The tool body 10 has the following elements.

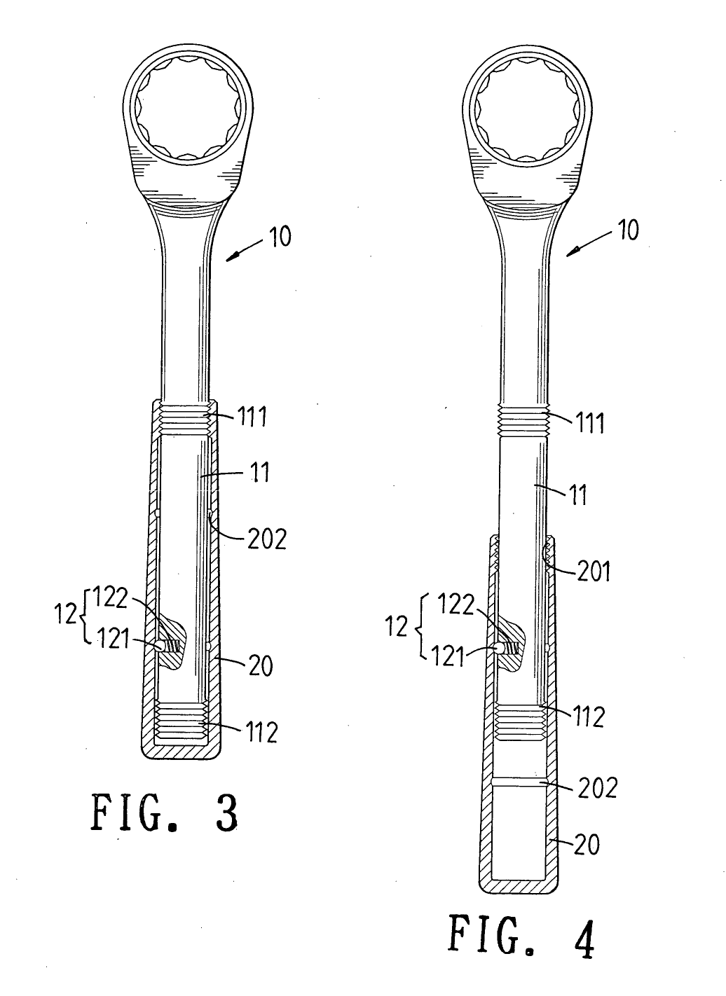

A handle 20 is included. Referring to FIG. 3, an upper opening end of the handle 20 has an inner thread 201.

A handle rod 11 has an upper outer thread 111 and a lower outer thread 112. A receiving hole 113 is formed above and near the lower outer thread 112 for receiving a resisting device 12. Thereby the resisting device 12 can be steadily screwed into the handle rod 11.

It should be noted that in the present invention, the number of the outer threads are not confined to the upper outer thread 111 and lower outer thread 112. There may be more outer threads being formed on the outer wall of the handle rod 11.

The resisting device 12 is formed by a steel ball 121 and a spring 122.

When the handle 20 is engaged to the handle rod 11, the inner thread 201 is used to engage the upper outer thread 111 or lower outer thread 112 so as to increase the stability of the engagement. An inner wall of the handle 20 is formed with a plurality of annular trenches 202. The resisting device 12 can resist against one of the annular trenches 202.

Thereby the handle rod 11 can be adjusted so that the resisting device 12 resists against one of the annular trench 202 and thus the length of the extendable handle device is adjusted to a desired length which is suitable to the operation.

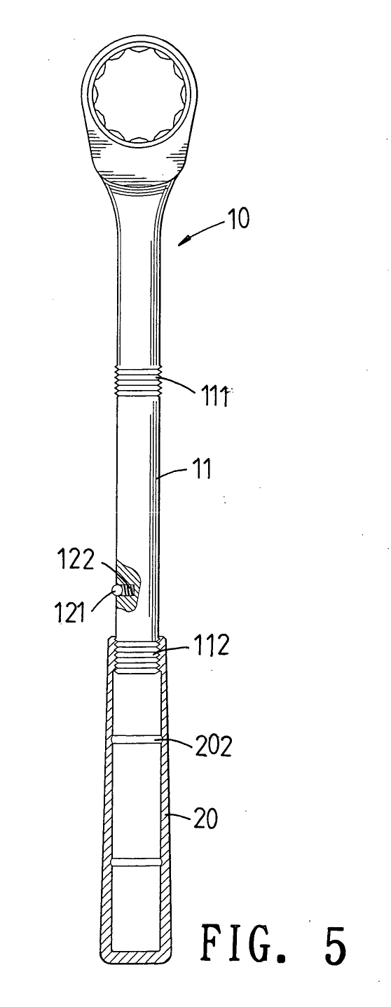

Referring to FIGS. 4 and 5, when the handle 20 is engaged to the handle rod 11, see FIG. 3, it is illustrated that the extendable handle device has an adjustable length by the resisting device 12 to resist against one of the annular trenches 202 to have a desired length. The longest length is that the inner thread 201 is engaged to the lower outer thread 112, as shown in FIG. 5.

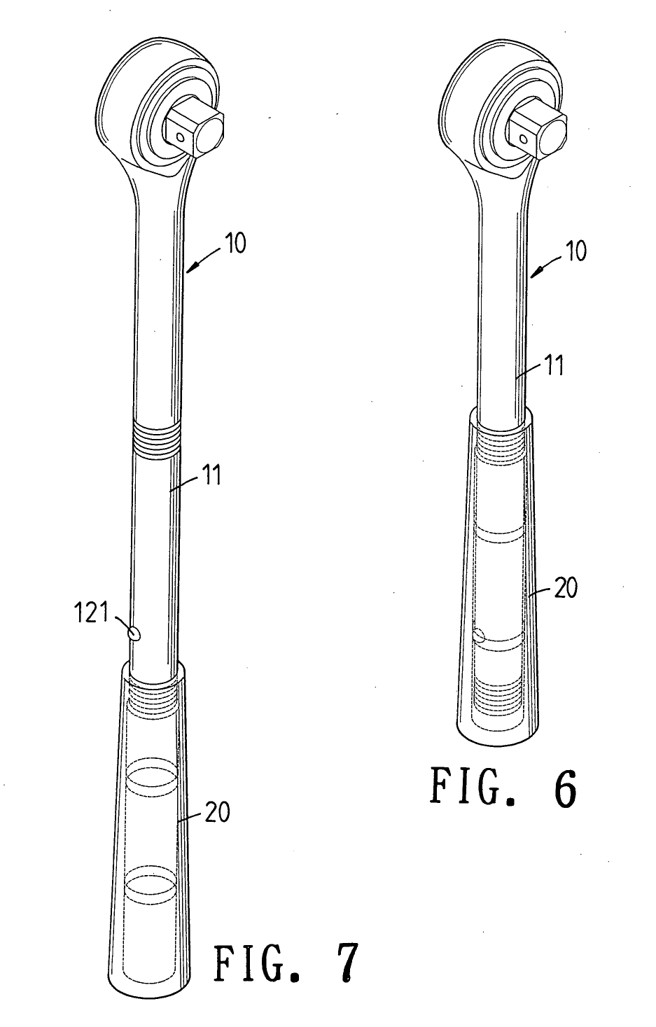

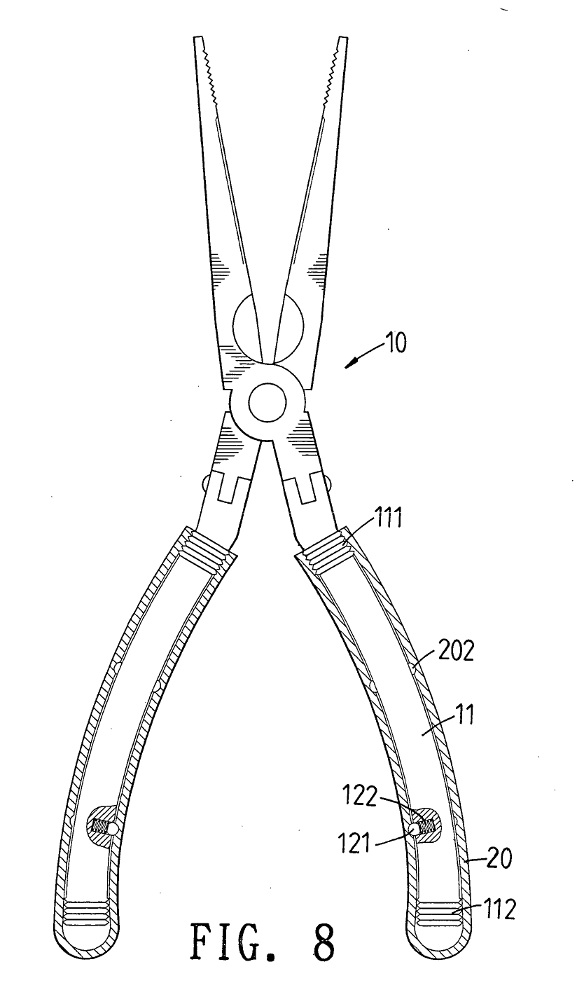

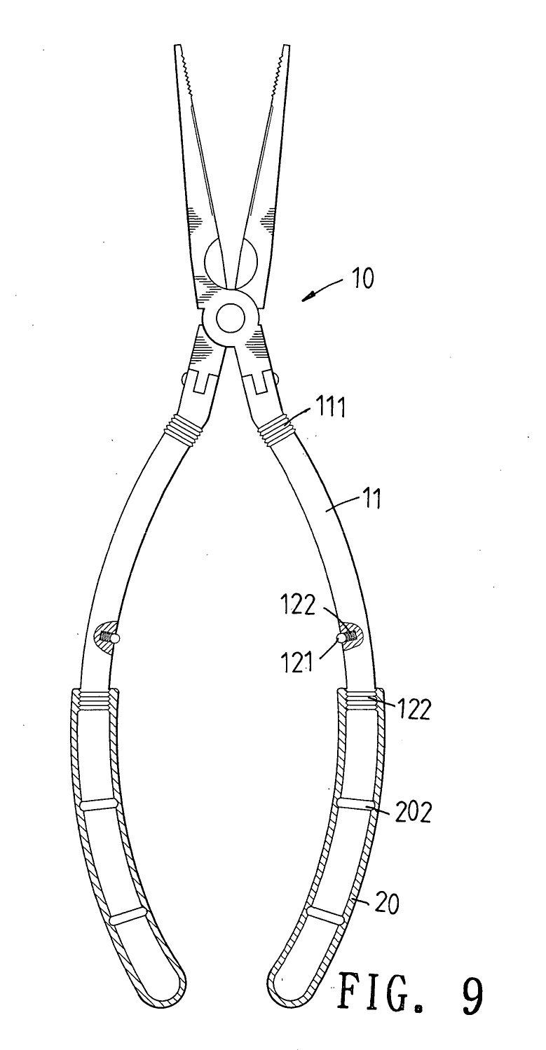

With reference to FIG. 6, another embodiment of the present invention is illustrated. it is illustrated that the present invention can be used to various hand tools, such as a spanner or an opener or a damper with two handles.

Advantages of the present invention will be described herein.

The formations of the upper outer thread 111, lower outer thread 112 and the inner thread 201 are helpful to the stability of the engagement of the handle rod 11 and the handle 20.

The present invention provides a maximum extension length by engaging the lower outer thread 112 of the handle rod 11 to the lower outer thread 112 of the handle 20.

In the present invention, the handle 20 has a larger lower end and a smaller upper end so that the handle rod 11 is easily slidable within the handle 20.

In the present invention, an outer surface of the handle 20 can be enclosed with a layer of plastic material so as to provide a preferred holding feeling and outlook to users.

Moreover, in the present invention, the spanner may be one of follow form spanners, sleeve spanners, ratchet spanners, adjust spanners, or other hand tools with holdable handles.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An extendable handle device comprising:
a handle; an upper opening end of the handle having an inner thread;
a handle rod having at least one outer thread at an outer wall thereof and a resisting device;
wherein when the handle is engaged to the handle rod, the inner thread is used to engage one of the at least one outer thread so as to increase the stability of the engagement; an inner wall of the handle is formed with at least one annular trench; the resisting device can resist against one of the at least one annular trench.

2. The extendable handle device as claimed in claim 1, wherein the resisting device includes a steel ball and a spring.

3. The extendable handle device as claimed in claim 1, wherein the outer wall of the handle rod has an upper outer thread and a lower outer thread.

4. The extendable handle device as claimed in claim 1, wherein the extendable handle device is a spanner with only one handle rod.

5. The extendable handle device as claimed in claim 1, wherein the extendable handle device is a damper with two handle rods.

6. The extendable handle device as claimed in claim 1, wherein an outer surface of the handle can be enclosed with a layer of plastic material
